(19) United States
(12) Patent Application Publication
(10) Pub. No.: US 2014/0154000 A1
(43) Pub. Date: Jun. 5, 2014

(54) Joint Mechanism for Connecting Adjacent Components

(71) Applicants: Louis Doucette, Acworth, GA (US); Justin Huffman, Painsville, OH (US)

(72) Inventors: Louis Doucette, Acworth, GA (US); Justin Huffman, Painsville, OH (US)

(21) Appl. No.: 14/093,467

(22) Filed: Nov. 30, 2013

Related U.S. Application Data
(60) Provisional application No. 61/732,286, filed on Nov. 30, 2012.

(51) Int. Cl. F16B 7/04

(52) U.S. Cl. CPC F16B 7/044
USPC 403/205; 29/525.01

(57) ABSTRACT

A joint mechanism is for connecting two adjacent components and has a first joint part with a shaped connector and a first receiver configured to receive a first component. A second joint part has a mating connector that engages the shaped connector fixing the first and second joint parts to one another and has a second receiver configured to receive a second component to be connected to the first component. At least one of the first and second receivers is a channel formed in the respective first or second joint part and has an open side that is covered by a portion of the other of the first and second joint parts when the shaped connector and the mating connector are fully engaged.

### RELATED APPLICATION DATA

This patent is related to and claims priority benefit of U.S. Provisional Patent Application Ser. No. 61/732,286 filed Nov. 30, 2012 and entitled “Joint Structure for Connecting Adjacent Components.” The entire content of this prior filed application is hereby incorporated herein by reference.

### BACKGROUND

1. Field of the Disclosure

The present disclosure is generally directed to mechanical joints, and more particularly to a joint mechanism configured to connect adjacent components.

2. Description of Related Art

Mechanical joints, joint devices, joint structures, and the like, hereinafter referred to as joint mechanisms, are known in the art for linking, connecting, or joining adjacent components. There are many different types of joint mechanisms. Sometimes it is desirable to connect two adjacent components to one another by a bracket or joint mechanism. The components may be configured so that the joint mechanism that will connect the components to one another must be coupled to both components before the components are subsequently connected or fixed to another larger structure or product.

In many instances, the bracket or joint mechanism is made of plastic. Often, the components form a sub-assembly that is intended to be attached to a larger structure or product. In many instances, the components are assembled to the larger structure or product by a method that requires application of intense heat, such as by welding one or both of the components to the larger structure. The intense heat may be transferred or conducted through the components, and, upon reaching the joint mechanism or bracket, cause damage to the plastic material of the joint mechanism or bracket already attached to the components.

To avoid this problem, one might wish to first connect the components to the larger structure and then subsequently attach the joint mechanism to connect the components to one another. However, if one or both of the components is welded to the larger structure, the typical joint mechanism cannot then be installed onto the components. This is because the ends of one or both of the components are fixed to the larger structure, leaving no free end of the component over which to install the joint mechanism.

In some instances, even though intense heat is not used to connect components, one might wish to have flexibility in the order of assembling various components of a larger structure or product. However, many known joint mechanisms and brackets must be installed over an end of a component before connecting the end of the component to another part. Thus, the typical joint mechanism or bracket can limit and hamper flexibility in the order of assembly of a product.

As an example of the aforementioned larger structure or product, a children's stroller includes a frame that has multiple metal frame elements or tubes that are interconnected with one another. Some of the frame connections are fixed joints, which can be welded, and some of the frame connections require a movable joint or connection. Movable joints or connections among the frame elements are often required so that the stroller frame can be folded and unfolded as is known in the art. In one example, two adjacent tubes of a stroller frame may need to be attached or connected to one another, and yet be capable of moving, such as by sliding and/or rotating, relative to one another in some manner during use. According to the above-noted problem, a pre-existing welded assembly that includes one or both of the tubes may prevent attaching any part of a joint mechanism onto either of the frame tubes. However, it might be undesirable to preassemble a joint mechanism or a part of such a mechanism onto the tubes prior to welding portions of the stroller frame together. This is particularly true when any part of the joint mechanism is made of a plastic material.

As noted above, there are many known solutions to these types of problems. However, such solutions typically include two joint parts that are fastened separately to the corresponding frame tubes and then further fastened to one another to complete the joint structure. Thus, assembly of such a joint mechanism requires several time consuming, tedious, manual steps to install the various joint parts and fasteners at each stage of assembly. Such a joint mechanism also requires use of numerous fasteners and/or fastening processes such as screws, welds, rivets, nuts and bolts, washers, and/or the like. For example, the Safety First “Aerolite” stroller has just such a joint construction and assembly dilemma. The solution on the Aerolite stroller uses multiple fasteners to attach the joint parts to one another once installed on the respective frame tubes.

### SUMMARY

In one example according to the teachings of the present invention, a joint mechanism for connecting two adjacent components is disclosed. The joint mechanism has a first joint part with a shaped connector and a first receiver configured to receive a first component. A second joint part has a mating connector that engages the shaped connector fixing the first and second joint parts to one another and has a second receiver configured to receive a second component to be connected to the first component. At least one of the first and second receivers is a channel formed in the respective first or second joint part. The channel has an open side that is covered by a portion of the other of the first and second joint parts when the shaped connector and the mating connector are fully engaged.

In one example, the joint mechanism can have a first component with a portion seated in the first receiver and can have a second component with a portion seated in the second receiver. The second component can be positioned adjacent the first component.

In one example, at least one of the first and second joint parts can be configured to be fastened to the respective first or second component.

In one example, the other of the first receivers can be an open ended but closed sided bore.

In one example, the shaped connector and the mating connector can engage one another with a snap connection.

In one example, the shaped and mating connectors can engage one another with a snap connection that is releasable and can include a spring finger on one of the first and second joint parts.

In one example, the joint mechanism can include a travel stop that limits relative travel between the first and second joint parts when connected to one another.

In one example, the first joint part can have a track or channel and the second joint part can have a corresponding guide that is slid into and along the track or channel when the first and second joint parts are connected.

In one example, the first and second receivers can be oriented so as to arrange the first and second components perpendicular to one another when connected.

In one example according to the teachings of the present invention, a joint assembly has first and second components configured to be connected to and positioned adjacent one another. The joint assembly also has a first joint part with a shaped connector and a first receiver. The first component is received in the first receiver. A second joint part has a second receiver and has a mating connector engaged to the shaped connector fixing the first and second joint parts to one another. The second component is received in the second receiver. At least one of the first and second receivers is a channel formed in the respective first or second joint part. The channel has an open side that is covered by a portion of the other of the first and second joint parts when the shaped connector and the mating connector engage one another thereby capturing the corresponding first or second component in the channel between the first and second joint parts.

In one example, one or both of the first and second components can be a tube or a bar.

In one example, the first and second components can be parts of a stroller frame.

In one example, the first and second joint parts can snap together when connected to one another.

In one example, the first and second joint parts can slide together when connected.

In one example, the first and second joint parts can slide together in a direction parallel to at least one of the first or second components when connected.

In one example, the shaped connector can be T-shaped and have a channel or track and the mating connector can be a guide shaped to slide within and along the channel or track.

In one example, at least one component of the first and second components can slide and/or rotate within the corresponding first or second receiver.

In one example, at least one component of the first and second components can slide and rotate relative to the corresponding first or second receiver.

In one example, both the first and second components can slide and/or rotate relative to the respective first and second receivers.

In one example according to the teachings of the present disclosure, a method of assembling a joint assembly includes providing a first joint part having a shaped connector and a first receiver and providing a second joint part having a mating connector and a second receiver. At least the second receiver is provided having a U-like or a C-like shape with an open side. A first component is positioned in the first receiver. A second component is placed through the open side into the second receiver. The shaped connector and the mating connector are engaged to fix the first and second joint parts to one another. The open side of the second receiver is covered by a portion of the first joint part capturing the second component within the second receiver when the joint parts are connected.

### BRIEF DESCRIPTION OF THE DRAWINGS

Objects, features, and advantages of the present invention will become apparent upon reading the following description in conjunction with the drawing figures, in which:

FIG. 1 shows a rear perspective view of one example of a product, depicted generically as a stroller, having joint assemblies constructed in accordance with the teachings of the present invention.

FIG. 2 shows a close up view of one of the joint assemblies taken from circle 2-2 of the stroller shown in FIG. 1.

FIG. 3 shows a perspective view of the joint mechanism of the joint assembly shown in FIG. 2, and in an assembled condition.

FIG. 4 shows a different perspective view of the assembled joint mechanism shown in FIG. 3.

FIG. 5 shows the joint mechanism of FIG. 4, but with the joint parts of the mechanism disassembled and detached from one another.

FIG. 6 shows a different perspective view of the disassembled joint mechanism of FIG. 5.

FIG. 7 shows a cross-section taken along line 7-7 of one of the joint parts of FIG. 6.

FIG. 8 shows another perspective view of the other joint part of FIG. 6.

FIG. 9 shows the joint assembly of FIG. 2 partially disassembled and viewed along an axis of one of the frame components of the stroller.

FIG. 10 shows the joint assembly of FIG. 9 but viewed in the direction of the arrows 10-10 along an axis of the other frame component.

FIG. 11 shows the joint assembly of FIG. 10 in a further but still partially assembled condition.

FIG. 12 shows a cross-section taken along line 12-12 of the partially assembled joint mechanism shown in FIG. 11.

FIG. 13 shows the joint mechanism of FIG. 11 but in the assembled condition of FIG. 2.

FIG. 14 shows the assembled joint mechanism of FIG. 13 but viewed in the direction of the arrows of line 14-14 along the axis of the other frame component as in FIG. 9.

FIG. 15 shows a cross-section taken along line 15-15 of the assembled joint assembly shown in FIG. 13.

FIG. 16 shows a cross-section taken along line 16-16 of the assembled joint assembly shown in FIG. 13.

### DETAILED DESCRIPTION OF THE DISCLOSURE

A joint mechanism, joint assembly, and method of assembling a joint connection two components are disclosed herein according to the teachings of the present disclosure. The disclosed joint mechanism solves or improves upon one or more of the above-noted and/or other problems and disadvantages with prior known joint mechanisms, joint assemblies, and assembly methods. The disclosed joint mechanism requires no separate fasteners to assemble or connect a first joint part to a second joint part. Thus, the disclosed joint mechanism requires no separate fasteners to assemble or connect a first component and a second component using the joint mechanism. The method of assembling two components using the disclosed joint mechanism is thus simpler and requires fewer components and steps in comparison to prior known similar joint mechanisms and assemblies.

The disclosed joint mechanism can also allow at least one component connected by the joint parts to freely rotate about its own axis when the mechanism is completely assembled. The disclosed joint structure can also allow at least one component connected by the joint parts to slide along its own axis relative to the assembled joint mechanism. The disclosed joint mechanism also allows the entire mechanism and at least one of the components joined thereby to rotate relative to or about the other component. The disclosed joint mechanism also allows the two connected components to be fixed or connected a larger structure, such as a stroller frame, prior to installation, assembly, and/or completion of the joint mechanism and final assembly of the joint parts. The disclosed joint mechanism also allows at least one of the joint parts to be installed on the respective component to be joined after the two components are assembled in a fixed relationship to a larger structure, such as a stroller frame. These and other objects, features, and advantages of the present invention will become apparent to those having ordinary skill in the art upon reading this disclosure.

Turning now to the drawings, FIG. 1 shows one example of a product that can benefit from incorporating a joint mechanism according to the teachings of the present invention. The product depicted is a stroller 20 that is well known and typically used to transport an infant or toddler. The stroller 20 has a frame assembly 22 supported by a plurality of wheels 24 on a surface. A seat assembly (not shown) is typically mounted on the frame assembly 22 and supported above the surface. The construction of the stroller 20, and particularly the configuration of the frame assembly 22, can vary considerably from the generic example shown in FIG. 1. The stroller 20 in FIG. 1 is shown merely as one of many possible products or structures that may advantageously benefit by employing a joint mechanism according to the teachings of this disclosure.

In this example, the frame assembly 22 has a handle assembly 26 having a handle bar 28 connected to a pair of push arms 30. The frame assembly 22 also has a pair of front legs 32 and a pair of rear legs 34. The left and right push arms 30, front legs 32, and rear legs 34 are joined on the left and right sides of the frame assembly at corresponding left and right fold joints 36, as is known in the art. In this example, the frame assembly 22 also has a rear cross-member 38 extending transversely between the rear legs 34. A basket frame 40 has a rear bar 42 extending between a pair of support arms 44, which extend rearward beyond the cross-member 38. In use, the support arms 44 and rear bar 42 may support a basket, often formed of soft goods (not shown), beneath the handle assembly 26 and behind and/or under the seat assembly. The support arms 44 in this example continue forward of the rear cross-member 38 and are each joined to a cover that defines an arm rest 46. The arm rests 46 in use would be on either side of the seat assembly. The arm rests 46 extend further forward and carry or integrally form a child's tray 48 that would be positioned in front of the seat assembly and be available for use by a child seat occupant.

In this example, the support arms 44 extend over the rear cross-member 38 and must be connected to the cross-member. As the stroller frame assembly 22 would be folded from the in-use configuration as shown to a folded configuration, the support arms 44 would pivot relative to the rear cross-member 38 while remaining connected thereto. The typical stroller would have a pivoting connection between each support arm 44 and the cross-member 38. However, the connection would have to be assembled to the cross-member 38 before the cross-member is attached to the rear legs 34. Alternatively, each connection would be a multi-component device that would have to be assembled onto the cross-member 38 and support arms 44 using fasteners and only after the cross-member were attached to the rear legs 34. In either case, the process to assemble the stroller frame assembly would be relatively complicated and require numerous discrete steps and/or would require a number of parts and fasteners.

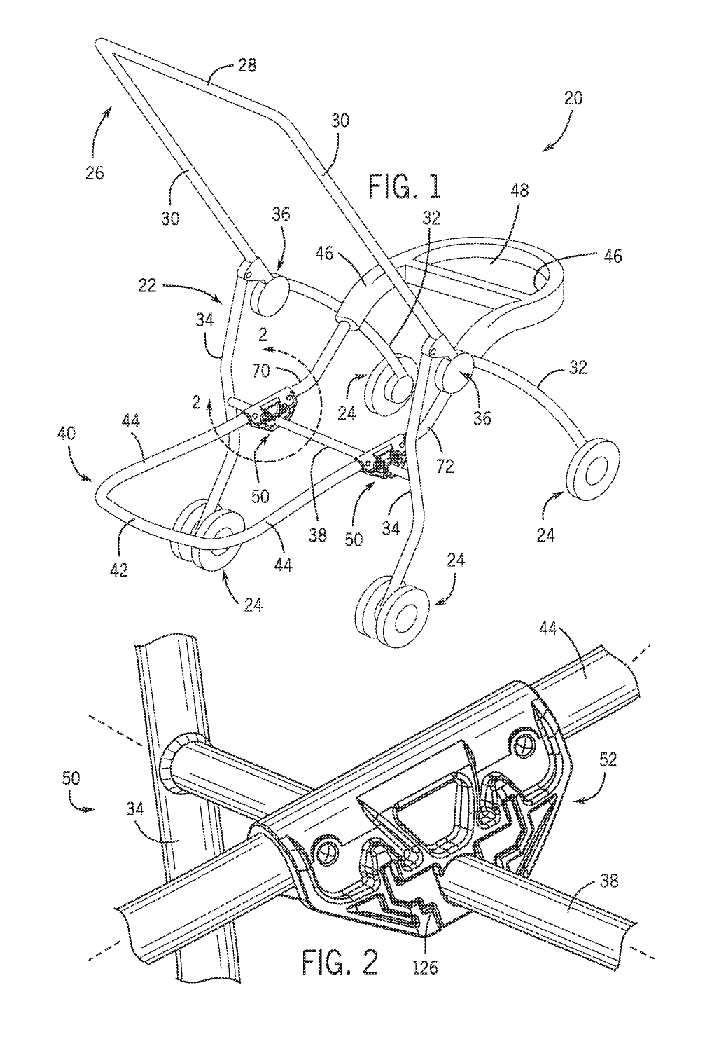

According to the teachings of the present invention, a joint assembly 50 is disclosed and includes a joint mechanism 52 for connecting the support arms 44 to the rear cross-member 38. The stroller 20 is shown in FIG. 1 as having two of the joint assemblies 50, one near each frame side. FIG. 2 shows a close up view of one of the joint assemblies 50. The configuration and construction of the joint assembly 50 can reduce the number of parts necessary, reduce the number of assembly steps required, simplify the assembly process, and allow flexibility in the specific order of the steps required to assemble the frame assembly 22. The joint mechanism 52, in combination with one of the support arms 44 and the cross-member 38 of the stroller 20 in this example, forms the joint assembly 50.

As will become evident to those having ordinary skill in the art upon reading this disclosure, the joint mechanism 52 may be useful for many other products and structures that incorporate components, which must be connected together. In these types of products, the cross-member 38 and support arm 44 would be replaced by components, such as frame element or the like of that product. In one example, the joint mechanism 52 can be used to connect frame components on other types of children's products that have a frame assembly, such as a bouncer seat, a playard, a child swing, or the like. The joint mechanism 52 can, however, also be used on other types of products that are not within the field of these types of children's products.

The joint assembly 50 disclosed herein generally has two components that are connected to one another by the joint mechanism 52. In this example, the two components are tubes that form part of the frame assembly 22. The support arm 44 and the cross-member 38 are connected to one another in this example so that they are generally perpendicular to one another. It is possible that the joint mechanism 52 is constructed in such a way so that the components connected by the joint mechanism are not perpendicular to one another. For the sake of convenience and simplicity in describing the disclosed joint assembly 50, the support arm 44 may be considered or described as the upper component herein and the rear cross-member 38 may be considered or described as the lower component. However, it is to be understood that the upper and lower components can more broadly represent first and second components to be connected by the joint mechanism and that the joint mechanism can be used in virtually any orientation needed for a particular product application.

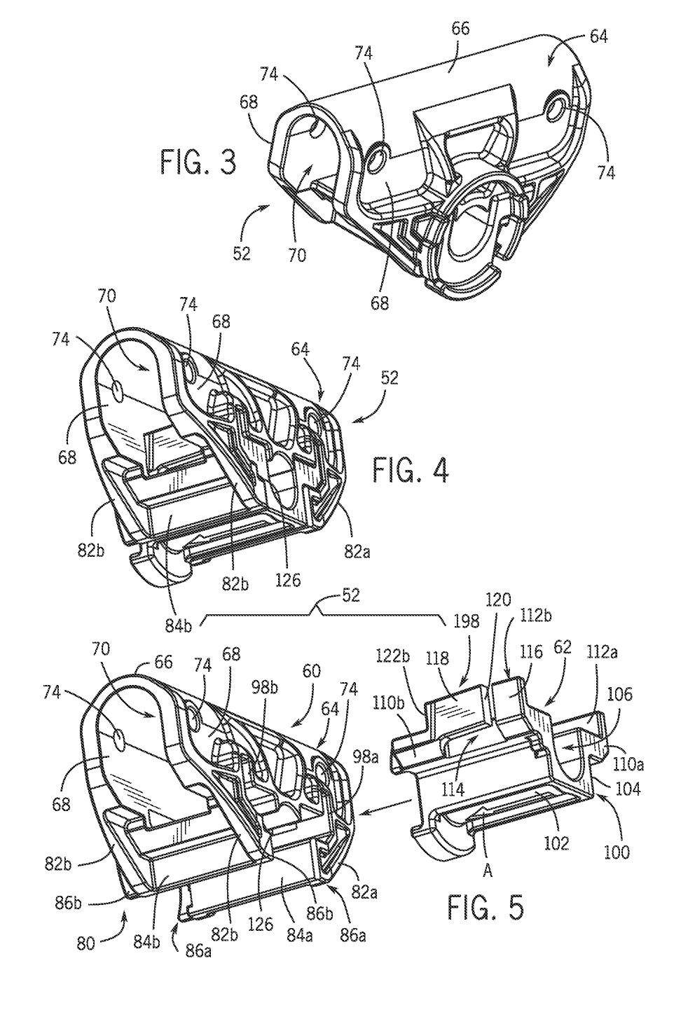

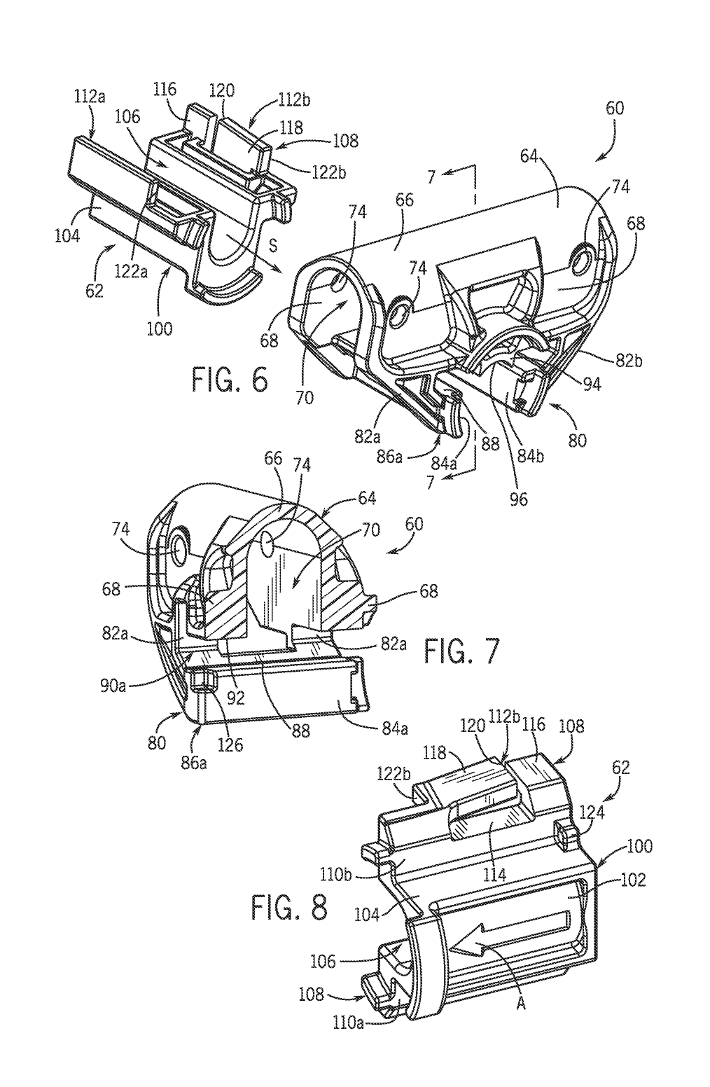

The disclosed example of the joint assembly 50 is now described in detail. FIG. 2 shows the joint assembly 40 in a completely assembled condition. FIGS. 3 and 4 show different views of the joint mechanism 52 in an assembled condition, but without the components of the joint assembly 50. FIGS. 5 and 6 show the joint mechanism 52 in a disassembled or detached condition. In this example, the joint mechanism 52 has two joint parts, hereinafter referred to as a first or upper joint part 60 and a second or lower joint part 62. The joint assembly 50, joint mechanism 52, or portions and parts thereof may at times be described herein using terms such as “upper”, “lower”, “top”, bottom”, “front”, “back”, “forward”, “rear”, “length”, “width”, and the like. Any such term referring to a direction or orientation is used herein merely to simplify the description such as to reference or orient one element, part, piece, component, or portion relative to another. The terms, when used herein, are not intended to limit the scope of the disclosure, and particularly are not intended to limit specific parts or components to having or to be capable of only having particular orientations or positions identified by those terms.

The first joint part 60 is shown in the drawings as the upper part and the second joint part 62 is shown as the lower part of the joint mechanism 52 when the two parts are assembled and connected to one another on the stroller 20. The first or upper joint part 60 is connected to the upper component, i.e., the support arm 44 in this example. The second or lower joint part 62 is connected to the lower component or rear cross-member 38 in this example.

The upper or first joint part 60 is somewhat saddle shaped having an inverted U-shaped or C-shaped body 64 with a closed, convex curved top wall 66. The body 64 has spaced apart depending side walls 68 and a lengthwise first receiver or component seat 70 extending between the side walls and beneath the top wall 66. The first receiver 70 in this example is an open ended through bore extending the length of the body 64. The first receiver 70 is shaped and configured to receive and closely fit the upper component, i.e. the support arm 44 through the body. The support arm 44 is a cylindrical tube so the receiver has a partial cylinder shape to match. The portion of the support arm 44 that is seated in the receiver 70 is linear so the through bore is also linear to match.

The support arm 44 has a bend 72 near the forward end before the connection to the arm rest 46. The first receiver 70 is cylindrical on the top and sides but is deeper at the bottom. During assembly, the first joint part 44 can be slipped over an exposed end of the support arm 44. The depth of the bottom of the receiver 70 permits the joint part 60 to slide past the bend 72. In this example, the first or upper joint part 60 optionally has a plurality of fastener holes 74 formed through the side walls 68. Fasteners 76 can be optionally installed through the holes 74 and into or through the support arm 44 in order to fix the joint part 60 to the support arm. It is possible however that the first joint part 60 not be fixed by fasteners 76 to the component to which it is attached. If not fixed in this manner, the component, i.e., the support arm 44 in this example may be capable of sliding axially within and/or rotating relative to the first joint part 60.

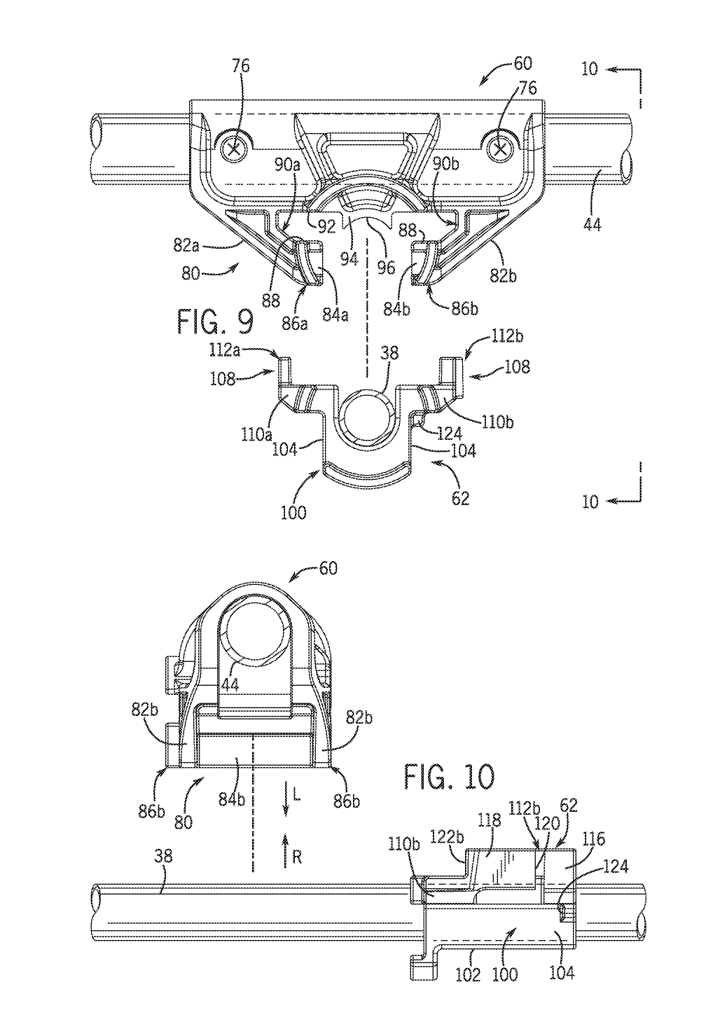

With reference to FIGS. 5-7, 9, and 10, the body 64 of the upper or first joint part 60 is also configured to create a shaped connector 80 below the first or upper receiver 70. In general, the shaped connector 80 is configured to connect the first joint part 60 to the second joint part 62 as described below. In this example, the shaped connector 80 has two pairs of laterally spaced apart legs 82a, 82b protruding from the bottom of the body 64, with one leg pair 82a nearer one end of the body and the other leg pair 82b nearer the other end. The pair of legs 82a at one end of the body 64 extends toward the pair of legs 82b at the other end of the body, as shown in FIG. 9. A bridge 84a, 84b is connected to the free ends 86a, 86b of the respective leg pairs 82a, 82b. The bridges 84a, 84b each extend laterally across the body 64 and define a bottom limit to the first receiver 70. The bridges 84a, 84b also partially close off free access to the receiver 70 via the bottom. The spacing between the bridges 84a, 84b defines a gap G between them. A top surface of each bridge 84a, 84b forms a guide surface 88. A channel or track 90a, 90b is defined above the guide surface 88, below a bottom edge 92 of the each side wall 68 by each pair of the legs 82a, 82b, also as best shown in FIGS. 6, 7, and 9. A standoff 94 protrudes down from the bottom edge 92 of each side wall 68 centrally between each pair of legs 82a, 82b. Each standoff 94 has a shaped bearing surface 96 facing toward the gap G between the bridges 84a, 84b.

As shown in FIGS. 4 and 5, one of the side walls 68 can have a vertical slot 98a, 98b associated with each of the respective channels or tracks 90a, 90b. The vertical slots 98a, 98b can extend up from part of each track 90a, 90b and through the thickness of the one side wall 68. The purpose of the various features and parts of the first joint part 60, including the slots 98a, 98b are described below.

The particular structure and configuration of the shaped connector 80 can vary within the spirit and scope of the present invention. Also, features of the disclosed shaped connector can also vary. The legs 82a, 82b in this example can have ribs, gussets, fillets and the like to add strength and rigidity to the mechanism 50. Each pair of legs can instead be a single leg structure. The channels or tracks 90a, 90b can have a different shape than that disclosed herein. These and other modifications to the shaped connector can be made without affecting the intended function of the joint mechanism 50.

The lower or second joint part 62 is best illustrated in FIGS. 5, 6, and 8-10. The second joint part 62 also has a body 100 that has somewhat of a U-shape or C-shape. The body 100 has a closed bottom wall 102 and a pair of upstanding side walls 104. The body defines a second receiver or component seat 106 that extends lengthwise along the body above the bottom wall 102 and between the side walls 104. The second receiver 106 in this example is an open ended channel extending the length of the body 100. The receiver 106 is shaped and configured to receive and closely fit the lower component, i.e. the rear cross-member 38 within the body. The rear cross-member 38 is also a cylindrical tube so the second receiver 106 has a partial cylinder shape to match. The rear cross-member 38 that is seated in the second receiver 106 is also linear so the channel is linear to match. In this example, the channel or second receiver 106 is upwardly open so the rear cross-member 38 can be seated directly into the channel slot.

The second joint part 62 has a mating connector 108 that is configured to engage the shaped connector 80 of the first joint part 60. In this example, the mating connector is created by two flanges 110a, 110b that are positioned at the respective upper ends of the corresponding side walls 104 adjacent the open end of the second receiver 106 or channel. The flanges 110a, 110b extend laterally outward from the side walls 104 and away from one another. The flanges 110a, 110b form slides or guides that are shaped and sized to fit within the channels or tracks 90a, 90b of the shaped connector 80. The body 100 of the lower or second joint part 62 below the flanges 110a, 110b is narrower in width that the span across the flanges and is sized to closely fit within the gap G between the bridges 84a, 84b of the shaped connector 80.

A fin 112a, 112b protrudes up from each of the respective flanges 110a, 110b. The fin 112a is a continuous solid element and extends only along a portion of the length of the flange 110a. The fin 112b also extends only a portion of the length of the flange 110b. The flange 110b has a cutout or notch 114 as shown in FIG. 8. A fixed portion 116 of the fin 112b is located at one end of the flange 110b and adjacent the cutout 114. The remainder of the fin 112b forms a spring finger or lock tab 118. One end of the spring finger 118 is resiliently fixed to the flange 112b opposite the fixed portion 116 of the fin 112b. A free end 120 of the spring finger 118 is adjacent the fixed portion 116. The spring finger 118 naturally rests with the free end 120 protruding outward out of plane with the fixed portion 116 of the fin 112b. The spring finger 118 can resiliently flex into the notch 114 as described below.

The mechanism 52 can have one or more travel stops that properly position the first and second joint parts 60 and 62 relative to one another when connected. One of the joint parts can have a stop or stop protrusion that hits a stop surface or contact surface of the other joint part when the two parts are connected. In one example, the fins 112a, 112b can have a length so that their exposed ends 122a, 122b hit the opposite side wall 68 when the two joint parts are connected. In another example, the second joint part 62 can have a stop or key 124 that protrudes from the outside of one of the side walls 68, as shown in FIG. 8. The first joint part 60 can have a keyway or stop seat 126 as shown in FIG. 7 that is positioned and configured to receive the stop or key 124 when the two parts are connected.

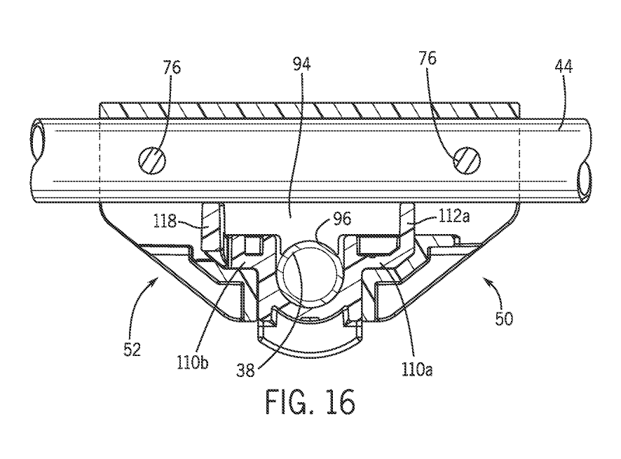

FIGS. 9-16 show the sequence for assembling the joint assembly 50 disclosed in this example of the invention. First, one of the components is seated in the first joint part and the other component is seated in the second joint part. The joint parts and components are then moved so that the shaped connector and the mating connector of the two joint parts are brought into alignment with one another. The two connectors are then engaged or connected to form the joint assembly.

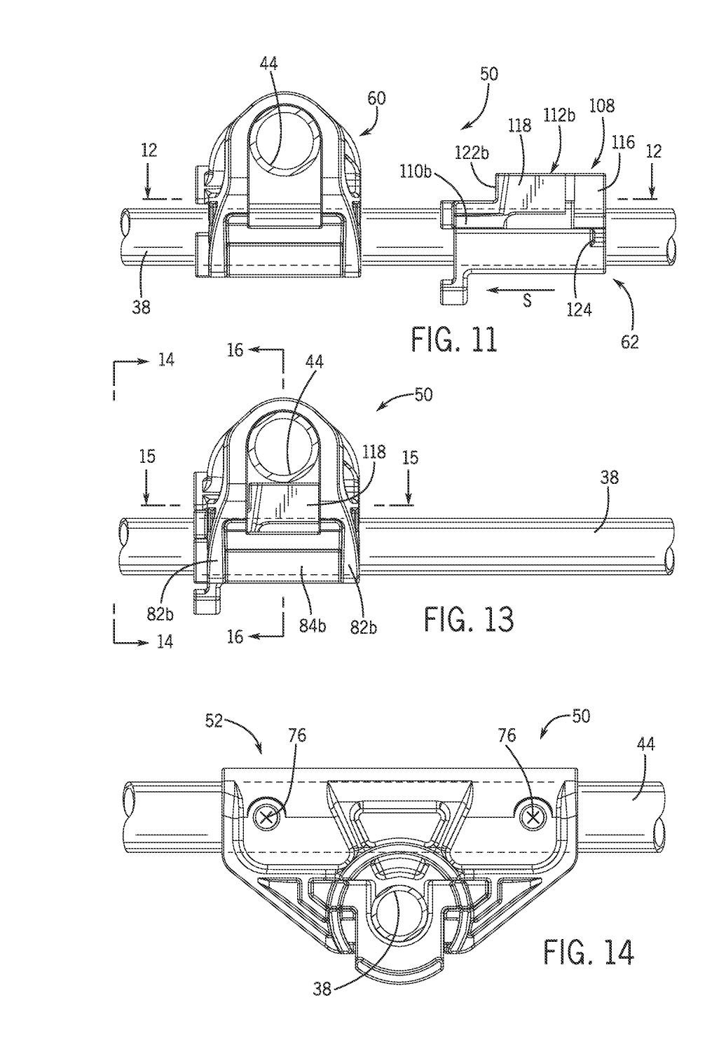

In this example, the support arm 44 is seated in the first receiver 70 by slipping the first joint part over an exposed end of the support arm tube. The fasteners 76 can then be installed in the holes 74 to optionally secure the first or upper joint part 60 to the support arm 44. The rear cross-member 38 can be welded to the rear legs 34 of the stroller frame 20. The other joints and connections of the larger structure, i.e., the stroller frame 22 in this example, can be set prior to the first joint part 60 being attached or after the first joint part is attached to the support arm 44. The second joint part 62 can be slipped under the rear cross-member 38, which can be seated in the second receiver 106 or channel. The arrangement of the components and parts at this point in the assembly process is reflected in FIGS. 9 and 10.

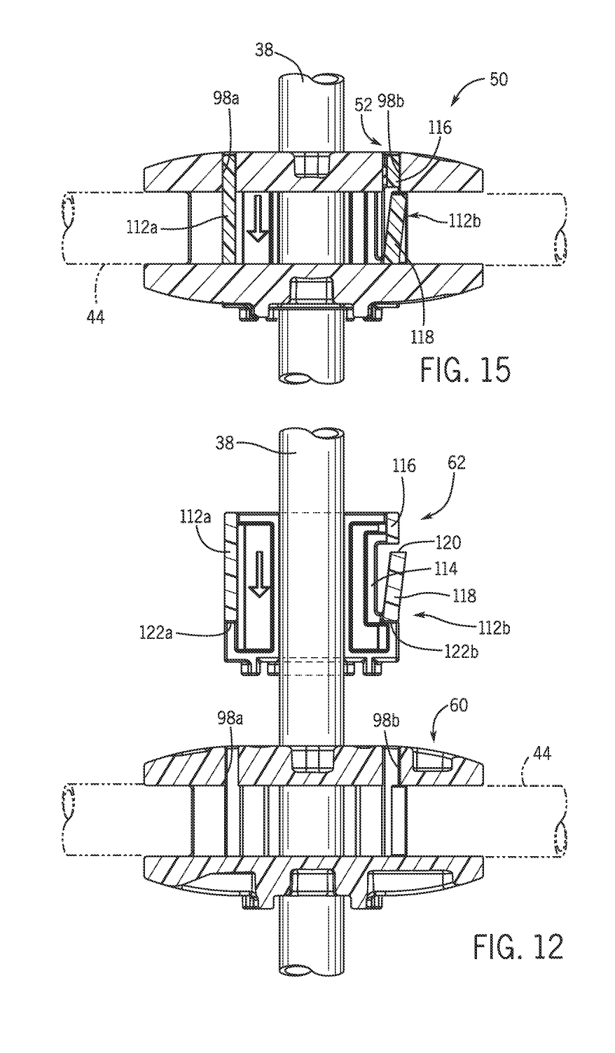

The support arm 44 and first joint part 60 can be positioned centered over the rear cross-member 38 as shown in FIG. 9. The first and second joint parts 60, 62 are first positioned vertically offset from one another as shown in FIG. 10. The support arm 44 and first joint part 60 can then be lowered onto the rear cross-member 38 as shown in FIGS. 11 and 12 until the cross-member seats against the bearing surfaces 96 on the standoffs 94. The second joint part 62 can then be slid in the direction of the arrow S of FIG. 11 and the arrow A on the underside of the second joint part into engagement with the first joint part 60. By doing so, the flanges 110a, 110b slide into the channels or track 90a, 90b, respectively, and the fins 112a, 112b slide into the slots 98a, 98b in the side wall facing the second joint part. The engaged joint parts can best be seen in FIGS. 13-16.

As the two joint parts 60, 62 are connected, the spring finger 118 will be pressed into the notch 114 upon pressure applied by the slot 98b. The flanges 112a, 112b will slide along the channels or tracks 90a, 90b guiding the second joint part 60 into engagement with the first joint part 60. As soon as the spring finger 118 passes beyond the thickness of the side wall 68, the spring finger will snap back to its rest position as best shown in FIG. 15. The spring finger 118 will prevent the second joint part 62 from being reversed back out of engagement with the first joint part 60. The exposed ends 122a, 122b of the fins 112a, 112b will also bottom against the opposite side wall 68 as shown in FIG. 15. Also, the stop or key 124 will seat in the keyway 126 to limit travel of the second joint part 62 relative to the first joint part 60.

The spring finger 118 will act as a lock to keep the two joint parts 60, 62 engaged. As shown in FIGS. 5, 11, and 13, the spring finger 118 is visible and accessible through the one end of the receiver 70 above the bridge 84b. If one wishes to disengage or detach the joint parts 60, 62 of the joint mechanism 50 and disassemble the joint assembly, the spring finger can be pushed inward so that the free end 120 clears the side wall 68. The second joint part 62 and the mating connector 108 can then be slid in reverse direction out of engagement with the first joint part 60 and the shaped connector 80.

As shown in FIGS. 9 and 10, the shaped connector 80 can be said to resemble a T-shaped slot or track. Likewise, the mating connector 108 can be said to resemble a T-shaped slider that fits within and slides along the slot or track. The shaped connector 80 and its associated parts can be varied from the configuration shown and described herein. Likewise, the mating connector and its associated parts can be varied from the configuration shown and described herein. The two joint parts 60, 62 can be designed to be flush with one another, as shown in FIGS. 2-4, 13, and 15, when the spring finger 118 is locked and the various stops are at their travel limit. The size, shape, placement, and the like of the spring finger, access window, stops and stop surfaces, and the like can also vary from the example disclosed and described herein.

In the completely assembled condition of FIGS. 2 and 13-16, the fixed upper joint part 60 and support arm 44 and the lower joint part 62 can rotate about the rear cross-member 38, if needed, such as for folding the stroller 20. If needed, the rear cross-member 38 can also slide axially through or relative to the assembled joint mechanism 52 in this example. In a different embodiment, if the upper component were not fastened to the upper joint part, the upper component could also slide axially and/or rotate relative to the assembled joint mechanism 52. The disclosed joint assembly 50 provides for a flexible assembly procedure to accommodate various larger structures while still yielding a very sturdy joint connection for the joined components such as the stroller frame tubes in this example.

The disclosed joint structure may be particularly useful when joining or connecting adjacent tubes to one another within a larger assembled structure, such as a stroller frame. However, the disclosed joint structure can certainly be used and may be quite useful in simplifying assembly in a wide variety of other types of structures that require adjacent components to be joined.

In the disclosed example, the upper tube (basket support arm 44) can be connected to the larger structure (frame assembly 22) and then the lower tube (cross-member 38) can be welded to the larger structure when forming the larger structure. The lower tube (cross-member 38) can get very hot during welding without causing any damage to the joint parts. This is because the joint parts do not yet touch the lower tube. If one were welding the upper tube and the lower tube, neither of the joint parts need be assembled until after welding. If needed, the legs 82a, 82b can be fabricated without the bridges 84a, 84b, leaving the receiver 70 open from the bottom. This would allow the first joint 60 to slide onto the support arm 44 or other component without having to slide the joint part over a free end of the component. In such an example, the open receivers would face one another in the connected joint mechanism so that both components are captured within the assembled joint mechanism without the need for separate fasteners.

In the disclosed example, the first component (support arm 44) and the second component (cross-member 38) are arranged perpendicular to one another. Also in the disclosed example, the shaped connector 80 is perpendicular to the first receiver 70 in the first joint part 60. Likewise, the mating connector 108 and the second receiver 106 are arranged parallel with one another to orient the components in the perpendicular arrangement. It is possible that the first and second receivers 70, 106 and the shaped connector 80 and the mating connectors 108 in other examples are oriented differently so that the connected components are arranged in different orientations. Also, it is possible that both the first and second receivers have an open side for side insertion of the components, similar to the second joint part 62 disclosed herein. It is also possible that the second joint part 62 is closed on all sides, similar to the first joint part 60 disclosed herein and that the first joint part has an open side.

In other examples, one or both of the joint parts can have a symmetrical shape. One or both of the receivers can be non-linear to accommodate a non-linear component. The receivers and/or components can be configured to permit only sliding movement, only rotational movement, rotational and sliding movement, or no movement of the associated component. The various walls of the bodies on each of the joint parts can also have ribs, gussets, fillets, holes, and the like in order to reduce material usage and/or enhance strength and rigidity. The disclosed first and second joint parts can each be formed as integral components. Each joint part can be formed of virtually any suitable material such as any plastic or thermoplastic (used generically), metal, alloy, composite, wood, or the like. For example, the joint parts can be Nylon and molded as two separate unitary parts. However, the joint parts can be formed by any suitable process or processes, depending on the materials selected. The two joint parts can also each be formed of a different material or can be formed of the same material.

In one example, the spring finger can be configured to provide or replaced with a one-way catch device to provide a permanent snap connection instead of the releasable snap connection disclosed and described above. In the disclosed example, the second joint part 62 slides in an axial direction relative to the second component when being connected to the first joint part 60. In other examples, the first joint part can slide relative to the second joint part. Alternatively, either or both joint parts can slide into engagement with one another in a direction that is not parallel or co-axial with either of the components. The shaped and mating connectors would have to configured so that engagement took place in a direction toward at least one of the components.

Although certain joint mechanisms, joint assemblies, and assembly methods have been described herein in accordance with the teachings of the present disclosure, the scope of coverage of this patent is not limited thereto. On the contrary, this patent covers all embodiments of the teachings of the disclosure that fairly fall within the scope of permissible equivalents.

What is claimed is:

1. A joint mechanism for connecting two adjacent components, the joint mechanism comprising:
a first joint part having a shaped connector and having a first receiver configured to receive a first component; and
a second joint part having a mating connector that engages the shaped connector fixing the first and second joint parts to one another, and having a second receiver configured to receive a second component to be connected to the first component,
wherein at least one of the first and second receivers is a channel formed in the respective first or second joint part, the channel having an open side that is covered by a portion of the other of the first and second joint parts when the shaped connector and the mating connector are fully engaged.

2. A joint mechanism according to claim 1,
a first component having a portion seated in the first receiver; and
a second component having a portion seated in the second receiver, the second component positioned adjacent the first component.

3. A joint mechanism according to claim 1, wherein at least one of the first and second joint parts is configured to be fastened to the respective first or second component.

4. A joint mechanism according to claim 1, wherein the other of the first receivers is a closed bore.

5. A joint mechanism according to claim 1, wherein the shaped connector and the mating connector engage one another with a snap connection.

6. A joint mechanism according to claim 5, wherein the snap connection is a releasable snap connection and includes a spring finger on one of the first and second joint parts.

7. A joint mechanism according to claim 1, further including a travel stop that limits relative travel between the first and second joint parts when connected to one another.

8. A joint mechanism according to claim 1, wherein the first joint part has a track or channel and the second joint part has a corresponding guide that is slid into and along the track or channel when the first and second joint parts are connected.

9. A joint mechanism according to claim 1, wherein the first and second receivers are oriented so as to arrange the first and second components perpendicular to one another when connected.

10. A joint assembly comprising:
first and second components configured to be connected to and positioned adjacent one another;
a first joint part having a shaped connector and having a first receiver, the first component received in the first receiver; and
a second joint part having a second receiver and having a mating connector engaged to the shaped connector fixing the first and second joint parts to one another, the second component received in the second receiver,
wherein at least one of the first and second receivers is a channel formed in the respective first or second joint part, the channel having an open side that is covered by a portion of the other of the first and second joint parts when the shaped connector and the mating connector engage one another capturing the corresponding first or second component in the channel between the first and second joint parts.

11. A joint assembly according to claim 10, wherein one or both of the first and second components is a tube or a bar.

12. A joint assembly according to claim 10, wherein the first and second components are parts of a stroller frame.

13. A joint assembly according to claim 10, wherein the first and second joint parts snap together when connected to one another.

14. A joint assembly according to claim 10, wherein the first and second joint parts slide together when connected in a direction parallel to at least one of the first or second components.

15. A joint assembly according to claim 10, wherein the shaped connector is T-shaped with a channel or track and wherein the mating connector is a guide shaped to slide within and along the channel or track.

16. A joint assembly according to claim 10, wherein at least one component of the first and second components can slide and/or rotate within the corresponding first or second receiver.

17. A joint assembly according to claim 16, wherein the at least one component can slide and rotate relative to the corresponding first or second receiver.

18. A joint assembly according to claim 10, wherein both the first and second components can slide and/or rotate relative to the respective first and second receivers.

19. A method of assembling a joint assembly, the method comprising the steps of:
providing a first joint part having a shaped connector and a first receiver and providing a second joint part having a mating connector and a second receiver, at least the second receiver having a U-like or a C-like shape with an open side;
positioning a first component in the first receiver;
placing a second component through the open side in the second receiver; and
engaging the shaped connector and the mating connector to fix the first and second joint parts to one another,
whereby the open side is covered by a portion of the first joint part capturing the second component within the second receiver.
